(19) United States
(12) Patent Application Publication
(10) Pub. No.: US 2009/0214087 A1
(43) Pub. Date: Aug. 27, 2009

(54) METHOD AND COMPUTER SYSTEM USING A WEBCAM FOR PROTECING DIGITAL DATA

(75) Inventor: Le-Shan HSUEH, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SILICON MOTION, INC., Hsinchu County (TW)

(21) Appl. No.: 12/127,915

(22) Filed: May 28, 2008

(30) Foreign Application Priority Data
Feb. 25, 2008 (TW) 97106440

(51) Int. Cl. G06K 9/78

(52) U.S. Cl. 382/118

(57) ABSTRACT

A method and computer system for digital data protection by using a webcam, comprising: generating a user's biometric feature image; comparing the biometric feature image with identification data; concealing specific data in the computer when the biometric feature image does not conform to the identification data.

### BACKGROUND OF THE INVENTION

1. Field of the Invention

The invention relates to digital data protection, and more particularly, to digital data protection by using a webcam.

2. Description of the Related Art

With technological advancements and lower cost structures, computers have become a common necessity for most in developed countries. As such, most computer users keep personal data on their computers. Therefore, protecting sensitive or confidential files of users (more importantly, corporate users) have become an important field of concern.

Common operating system (OS), like Windows OS by Microsoft for example, provide digital data protection by encrypting the OS after idling for a preset period of time, wherein users must input a cipher to re-activate the OS. Additionally, individual files or folders within a computer system may also be protected by the same cipher method. However, inputting ciphers are inconvenient for users. In addition, encrypted files often draw the attention of user's not allowed to use the computer system, and hacking into encrypted files is always possible. As such, recently, biometric recognition devices are being used to replace the cipher protection method using keyboards. However, two types of commonly applied biometric recognition devices, fingerprint and iris recognition devices, are contact-type methods. As such, additional effort of the user is required, as with the cipher protection method. Therefore, it is important to provide a more convenient and effective method for protecting digital data.

### BRIEF SUMMARY OF INVENTION

The invention provides a method for protecting digital data in a computer by using a webcam. The method comprises generating a user's biometric feature image from the webcam, comparing the biometric feature image with identification data, and concealing specific data when the biometric feature image does not conform to the identification data.

The invention also provides a computer system for protecting digital data. The computer system comprises a webcam to generate a user's biometric feature image, a storage device to store identification data, and a control device to compare the biometric image with the identification data and conceal specific data when the biometric feature image does not conform to the identification data.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram of a computer system comprising a webcam.

FIG. 2 is a schematic diagram of a computer system using a webcam for digital data protection according to the invention.

FIG. 3 is a flow chart of the method for protecting digital data by using a webcam according to the invention.

FIG. 4 is a flow chart of the method for establishing the identification data according to the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

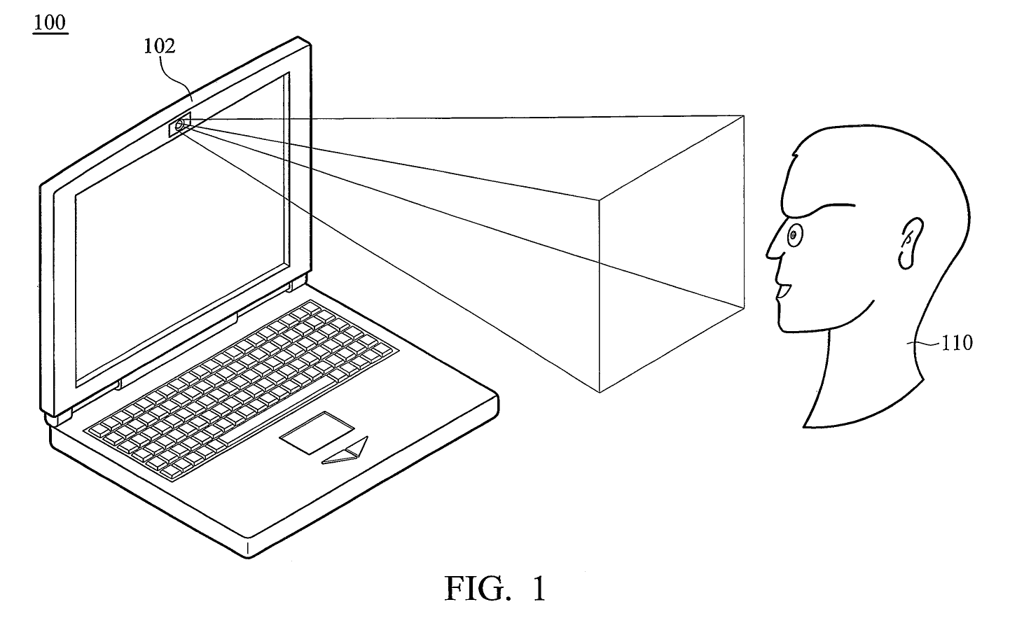

FIG. 1 shows a computer system 100 comprising a webcam 102. (Note that a notebook computer is used as an example, however, the invention is not limited thereto.) The invention is an application of biometric recognition technology practiced via webcams. Biometric recognition technology mostly focuses on facial recognition. Thus, since a notebook computer is normally operated with the webcam facing the face of users, the deficiencies in the prior art discussed above are prevented. Thus, applying the invention to a notebook computer is a preferred embodiment. However, those skilled in the art should understand that the invention may also be applied to a desktop computer comprising a webcam or other like devices.

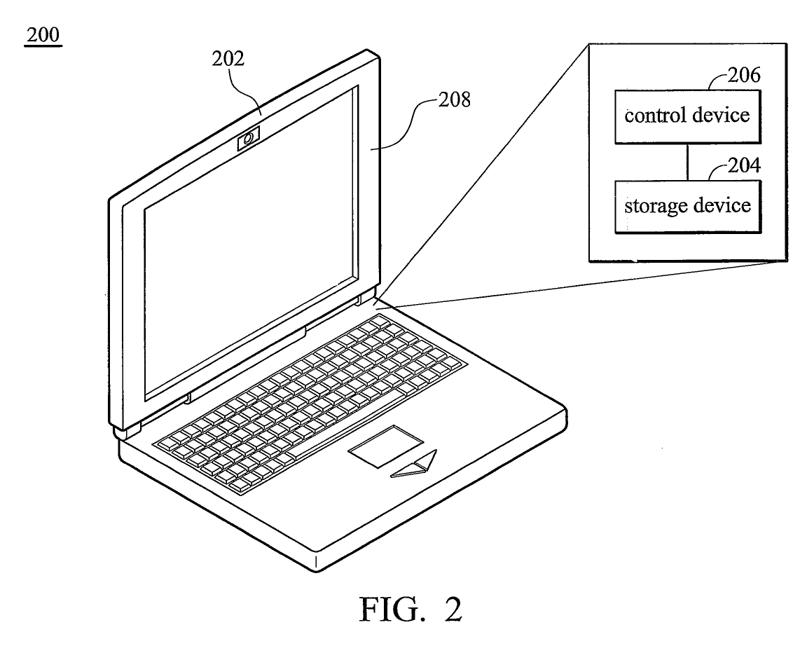

FIG. 2 shows a computer system 200 using a webcam 202 for digital data protection according to the invention. A computer system 200 comprises a webcam 202 to generate a user's biometric feature image, a storage device to store identification data, which further comprises biometric feature data of an original user, and a control device 206 to compare the generated biometric feature image with the identification data stored in the storage device 204. When the biometric feature image does not conform to the identification data, which means that the user is not an original user allowed to use the computer system 200, the control device 206 conceals specific data which the original user allowed to use the computer system 200 regards as sensitive or confidential data, by concealing the specific data on the display device 208. Alternatively, when the biometric feature image does conform to the identification data, the computer system 200 regards the user as a user allowed to use the computer system 200, no further action is performed by the computer system 200, and the specific data on the display device 208 is not concealed. Note that the specific data may be any kind of file or folder in any computer system. Also note that the identification data described above comprises biometric feature data of the original user, and the biometric feature data is usually information of facial features, such as relative outlined sizes of facial sense organs and a face, and relative position, distance and angel of the facial sense organs such as eyes, ears, nose and mouth. Additionally, the interocular distance of the original user may be taken as the identification data. A function of the control device 206 is to convert the biometric feature image generated by the webcam 202 into biometric feature data. If identification data is set to be the interocular distance of the original user, the biometric feature data should be the interocular distance of the user.

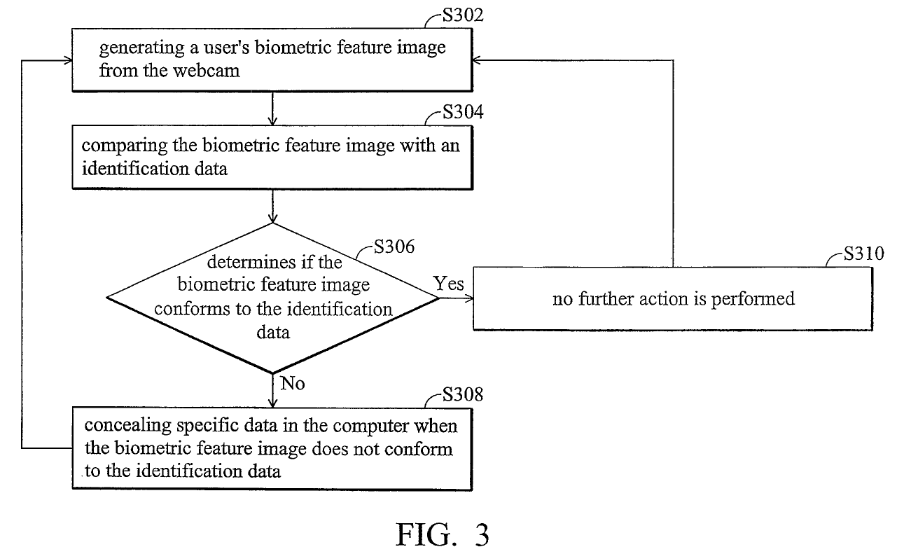

FIG. 3 is a flow chart of the method for protecting digital data by using a webcam according to the invention. Referring to FIG. 3 and FIG. 2, in the step S302, the computer system 200 generates a user's biometric feature image by the webcam 202. In the step S304, the control device 206 compares the biometric feature image with identification data. The step S304 further comprises converting the biometric feature image into biometric feature data before comparison with the identification data. As mentioned above, the biometric features data is usually information of facial features such as the relative position, distance and angles of facial sense organs, or relative outlined sizes of facial sense organs and a face. For example, information of facial features may indicate the interocular distance of the original user. If the identification data is set to be the interocular distance of the original user, the biometric feature data should be the interocular distance of the user. In the step S306, the control device 306 determines if the biometric feature image conforms to the identification data. If the biometric feature image does not conform to the identification data, the computer system 200 determines that the user is not the original user allowed to use the computer system 200, and the computer system 200 processes the next step S308, wherein the control device 206 conceals the specific data which the original user allowed to use the computer system 200 regards as sensitive or confidential data. Accordingly, the specific data may not be shown on the display device 208. Alternatively, if the biometric feature image does conform to the identification data, the computer system 200 determines that the user is the original user allowed to use the computer system 200, and the computer system 200 processes the next step S310, wherein no further action is performed by the control device 206. Accordingly, the specific data may be shown on the display device 208. Note that the computer system 200 repeats all the aforementioned steps, from step S302, after performing the step S308 and the step S310. Those skilled in the art should understand that the webcam may be preset to generate a user's biometric feature image at every specific interval, for example, every five minutes, to adjust the degree of digital data protection.

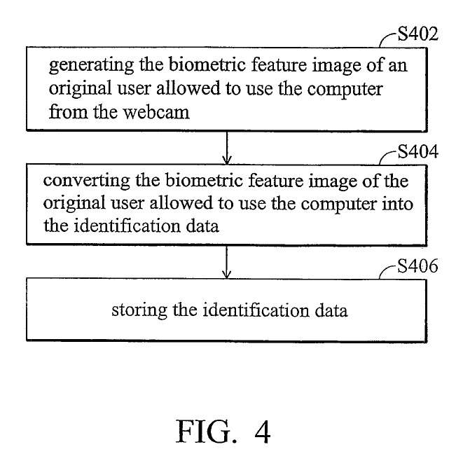

Referring to FIG. 2 and FIG. 4, the step of establishing the identification data further comprises generating S402 a biometric feature image of an original user allowed to use the computer system by the webcam 202, and converting S404 the biometric feature image of the original user allowed to use the computer system 200, by the control device 206, into the identification data, which comprises biometric feature data of the original user. Additionally, the step of establishing the identification data further comprises storing S406 of the identification data in the storage device 204. Those skilled in the art should understand that only the original user allowed to use the computer system 200, is allowed to add, modify or remove the identification data. Specifically, only the original user allowed to use the computer system 200 may encrypt the identification data. To strengthen the degree of digital data protection, the step for generating a user's biometric feature image may be preset to initiate automatically every time the computer system 200 is activated.

Biometric features mentioned above, comprises information of facial features. In addition to relative position, distance and angle of facial features, information of a user's facial features further comprise relative sizes of the facial features. As biometric recognition and optical image technology advances, the invention may be more broadly applied. For example, if the webcam has infrared photography capabilities, a user's infrared image may be generated, and the invention may be applied using the user's infrared image.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for protecting digital data in a computer by using a webcam, comprising:
generating a user's biometric feature image from the webcam;
comparing the biometric feature image with an identification data; and
concealing specific data in the computer when the biometric feature image does not conform to the identification data.

2. The method for protecting digital data in a computer by using a webcam as claimed in claim 1, wherein the method further comprises converting the biometric feature image into biometric feature data before comparison with the identification data.

3. The method for protecting digital data in a computer by using a webcam as claimed in claim 2, wherein the identification data comprises biometric feature data of an original user allowed to use the computer.

4. The method for protecting digital data in a computer by using a webcam as claimed in claim 2, wherein the biometric feature data comprises information of a user's facial features.

5. The method for protecting digital data in a computer by using a webcam as claimed in claim 1, wherein the step of generating is repeated at every specific interval.

6. The method for protecting digital data in a computer by using a webcam as claimed in claim 1, wherein the step of generating is automatically initiated when the computer is activated.

7. The method for protecting digital data in a computer by using a webcam as claimed in claim 1, wherein the method further comprises a step of establishing the identification data, comprising:
generating the biometric feature image of an original user allowed to use the computer from the webcam;
converting the biometric feature image of the original user allowed to use the computer into the identification data; and
storing the identification data.

8. The method for protecting digital data in a computer by using a webcam as claimed in claim 7, wherein the method further comprises encrypting the identification data.

9. The method for protecting digital data in a computer by using a webcam as claimed in claim 4, wherein information of a user's facial features comprises relative outlined sizes of facial sense organs and a face.

10. The method for protecting digital data in a computer by using a webcam as claimed in claim 4, wherein information of a user's facial features comprises relative positions, distances and angles of facial sense organs.

11. The method for protecting digital data in a computer by using a webcam as claimed in claim 10, wherein the relative positions, distances and angles of the facial sense organs further comprises information of interocular distance.

12. The method for protecting digital data in a computer by using a webcam as claimed in claim 1, wherein the webcam is able to extract a user's infrared image.

13. A computer system for protecting digital data, comprising:
a webcam for generating a user's biometric feature image
a storage device for storing identification data; and
a control device for comparing the biometric feature image with the identification data and concealing specific data in the computer when the biometric feature image does not conform to the identification data.

14. The computer system as claimed in claim 13, wherein the control device further converts the biometric feature image into biometric feature data before comparison with the identification data.

15. The computer system as claimed in claim 13, wherein the identification data comprises biometric feature data of an original user allowed to use the computer.

16. The computer system as claimed in claim 14, wherein the biometric feature data comprises information of a user's facial features.

17. The computer system as claimed in claim 16, wherein information of a user's facial features comprises relative outlined sizes of facial sense organs and a face.

18. The computer system as claimed in claim 16, wherein information of a user's facial features comprises relative positions, distances and angles of facial sense organs.

19. The computer system as claimed in claim 16, wherein the facial features comprise relative positions, distances and angles of the facial sense organs further comprise information of interocular distance.
